(19) United States
(12) Patent Application Publication
(10) Pub. No.: US 2021/0028485 A1
(43) Pub. Date: Jan. 28, 2021

(54) LITHIUM ION SECONDARY BATTERY

(71) Applicant: NEC CORPORATION, Tokyo (JP)

(72) Inventors: Kazuhiko INOUE, Tokyo (JP); Kenichi SHIMURA, Tokyo (JP)

(73) Assignee: NEC CORPORATION, Tokyo (JP)

(21) Appl. No.: 16/980,479

(22) PCT Filed: Mar. 20, 2019
(86) PCT No.: PCT/JP2019/011711

§ 371 Date: Sep. 14, 2020

(30) Foreign Application Priority Data
Mar. 22, 2018 (JP) 2018-054602

(51) Int. Cl. H01M 10/0525; H01M 10/0569; H01M 4/36; H01M 4/62; H01M 2/16; H01M 10/0567

(52) U.S. Cl. CPC H01M 10/0525; H01M 10/0569; H01M 4/366; H01M 2004/027; H01M 2/1653; H01M 10/0567; H01M 4/622

(57) ABSTRACT

An object of one embodiment of the present invention is to provide a lithium-ion secondary battery with high safety in which deterioration of a separator comprising polyethylene terephthalate is suppressed even when an electrolyte solution comprising a carbonate-based solvent is used. A first lithium ion secondary battery of the present invention is a lithium ion secondary battery comprising an electrode laminate comprising a positive electrode, a negative electrode and a separator, and an electrolyte solution, wherein the negative electrode comprises a solution type binder, the separator comprises polyethylene terephthalate, and the electrolyte solution comprises a solvent comprising a compound having a carbonate group.

### TECHNICAL FIELD

The present invention relates to a lithium ion secondary battery, a method for manufacturing the same, and a vehicle equipped with the lithium ion secondary battery.

### BACKGROUND ART

Polyethylene terephthalate (PET), which has a relatively high melting point, has been used as the separator in order to improve the safety of lithium ion secondary batteries. Carbonate-based solvents have been generally used as electrolyte solutions for the lithium ion secondary batteries. For example, Patent Document 1 discloses a lithium ion secondary battery using a microporous film formed by PET and a carbonate-based solvent.

### CITATION LIST

### Patent Document

Patent Document 1: Japanese Patent Laid-Open Publication No. 2003-187867

### SUMMARY OF INVENTION

### Technical Problem

However, the separator comprising PET is easily deteriorated when a carbonate-based solvent is used as the electrolyte solution, and it has been confirmed that the separator is discolored or disappeared after charging and discharging. As a result of investigating such deterioration of the separator, the deterioration tends to particularly progress in a portion in contact with the negative electrode. Thus, it is inferred that the decomposition product of the carbonate-based solvent such as the alkoxy ion generated in the negative electrode reacts with PET to cause deterioration. In order to suppress such decomposition of the solvent, it has been known to mix an additive with the electrolyte solution for forming a film on the electrode. For example, in the battery described in the above Patent Document 1, vinylene carbonate is used as an additive in order to suppress decomposition of the electrolyte solution on the negative electrode. However, the deterioration of the separator comprising PET could not be sufficiently suppressed only by using the additive. In view of the above-mentioned problems, an object of one example embodiment of the present invention is to provide a lithium ion secondary battery in which a separator comprising PET is less likely to deteriorate even when an electrolyte solution comprising a carbonate-based solvent is used.

### Solution to Problem

A first lithium ion secondary battery of the present invention is a lithium ion secondary battery comprising an electrode laminate comprising a positive electrode, a negative electrode and a separator, and an electrolyte solution, wherein the negative electrode comprises a solution type binder, the separator comprises polyethylene terephthalate, and the electrolyte solution comprises a solvent comprising a compound having a carbonate group.

### Advantageous Effect of Invention

According to the present invention, there can be provided a lithium ion secondary battery in which a separator comprising PET is less likely to deteriorate even when an electrolyte solution comprising a carbonate-based solvent is used.

### BRIEF DESCRIPTION OF DRAWING

FIG. 1 is is an exploded perspective view showing a basic structure of a film-packaged battery.

FIG. 2 is a schematic sectional view showing a structure of a battery of FIG. 1.

FIG. 3 is sectional view of the electrode laminate.

FIG. 4 is a sectional view of an electrode laminate in which the outermost layer is a separator.

### DESCRIPTION OF EMBODIMENTS

Hereinafter, an example of the lithium ion secondary battery according to the present example embodiment will be described for each component.

### [Separator]

The lithium ion secondary battery of the present example embodiment has a separator comprising PET. Hereinafter, in this specification, a separator comprising PET is also referred to as a PET separator. PET has a high melting point of 280° C. and is excellent in heat resistance. Therefore, if the PET separator is used, safety can be ensured even in a battery having a high energy density in which the inside temperature may be high. The PET separator may have a single-layer structure or a laminated structure. In the case of a laminated structure, the PET separator comprises a PET layer containing PET. The PET separator may comprise additives such as inorganic particles. The content of PET in the PET separator or in the PET layer is preferably 50% by mass or more, more preferably 70% by mass or more, and may be 100% by mass.

When the PET separator has a laminated structure, the material used for layers other than the PET layer is not particularly limited, but examples thereof include polyesters other than PET such as polybutylene terephthalate and polyethylene naphthalate, polyolefins such as polyethylene and polypropylene, and aromatic polyamides (aramids) such as polymetaphenylene isophthalamide, polyparaphenylene terephthalamide and copolyparaphenylene-3,4′-oxydiphenylene terephthalamide, polyimides, polyamideimides, cellulose and the like. As described later, the PET separator may have an insulation layer.

Any shape of the PET separator, for example, a fiber assembly such as a woven fabric or a non-woven fabric and a microporous membrane may be used. The woven or non-woven fabric may comprise a plurality of fibers that are different in material, fiber diameter, or the like. Further, the woven fabric or the non-woven fabric may comprise a composite fiber containing a plurality of materials.

The porosity of the microporous membrane and the porosity (void ratio) of the non-woven fabric used for the PET separator may be appropriately set depending on the characteristics of the lithium ion secondary battery. In order to obtain good rate characteristics of the battery, the porosity of the PET separator is preferably 35% or more, more preferably 40% or more. In order to increase the strength of the separator, the porosity of the PET separator is preferably 80% or less, more preferably 70% or less.

The porosity of the separator can be calculated by measuring the bulk density in accordance with JIS P 8118 and using the following formula:

Porosity (%)=[1−(bulk density ρ (g/cm³)/theoretical density ρ₀ of material (g/cm³))]×100

Examples of other measurement methods include direct observation with an electron microscope and a pressure filling with a mercury porosimeter.

The PET separator in the present example embodiment preferably has a high air permeability. The Gurley value of the PET separator is preferably 100 sec/100 cc or less, more preferably 50 sec/100 cc or less, still more preferably 20 sec/100 cc or less. The lower limit of the Gurley value of the PET separator is, for example, preferably 0.01 sec/100 cc or more.

A thicker PET separator is preferable in terms of maintaining insulation and strength. On the other hand, in order to increase the energy density of the battery, the thinner PET separator is preferable. In the present example embodiment, in order to prevent short circuit and to provide heat resistance, the thickness of the PET separator is preferably 3 μm or more, more preferably 5 μm or more, and still more preferably 8 μm or more. In order to meet the battery specifications such as energy density that is usually required, the thickness of the PET separator is preferably 40 μm or less, more preferably 30 μm or less, and further preferably 25 μm or less.

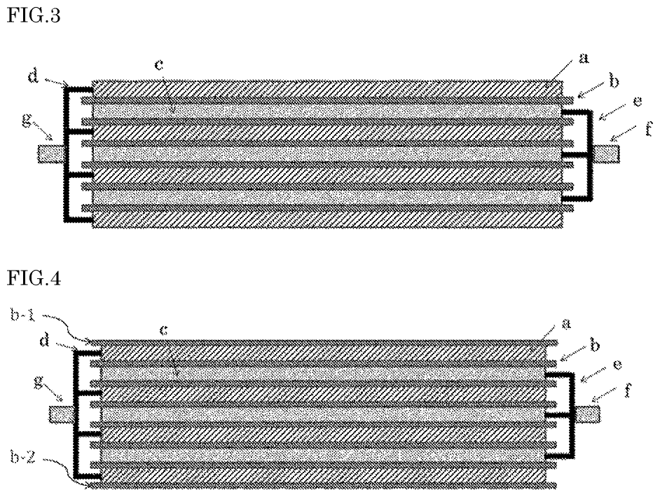

Depending on the structure of the battery, the progress rate of the deterioration of the PET separator is different. In particular, the arrangement and size of the electrode and the PET separator have a large influence on the progress rate of deterioration of the PET separator. The present invention can suppress the deterioration of the PET separator and obtain a higher effect even if the battery has a structure in which the PET separator easily deteriorates. In this specification, the separator is classified into an intermediate layer separator and an outermost layer separator by the setting position. Generally, a positive electrode and a negative electrode are stacked via a separator to form an electrode laminate. For example, in FIG. 3, the negative electrodes a and the positive electrodes c are alternately stacked with the separator b interposed therebetween. Such a separator between the positive electrode and the negative electrode is referred to as an intermediate layer separator. As shown in FIG. 3, in the electrode laminate in which all the separators are the intermediate layer separators, the electrodes are arranged at the lowermost part and the uppermost part (outermost layers). On the other hand, in a stacked type battery (particularly a zigzag type battery), the separator may be arranged at the uppermost part and/or the lowermost part of the electrode laminate from the viewpoint of being advantageous in manufacturing. FIG. 4 shows an example of such an electrode laminate. In FIG. 4, the separator b-1 and the separator b-2 are respectively provided at the uppermost part and the lowermost part. Further, in the zigzag-type battery, one separator is folded in a zigzag manner and electrodes are inserted therebetween, so that the uppermost part and the lowermost part of the electrode laminate are the separators. In other cases, wrapping the electrode laminate with a separator may prevent displacement of the electrode laminate, and in this case also, the separator is positioned at the uppermost part and the lowermost part of the electrode laminate. The separator at the uppermost part or the lowermost part of such an electrode laminate is referred to as the outermost layer separator. Although the outermost layer separator does not prevent contact between the positive electrode and the negative electrode, it is the same as the intermediate layer separator and thus it is referred to as a separator in this specification. The progress rate of PET deterioration is different between the intermediate layer separator and the outermost layer separator. Hereinafter, an embodiment in which the effect of the present invention is more remarkable will be described.

In one example embodiment, the PET separator preferably has a portion that is not in contact with the positive electrode. The separator is usually designed to be larger than the negative electrode and the positive electrode in order to enhance the safety against the displacement of the electrode laminate. In this case, whether the separator is the intermediate layer separator or the outermost layer separator, at least the outer portion thereof is not contact with the positive electrode. The PET separator easily deteriorates in such a portion that is not in contact with the positive electrode. However, according to the present invention, deterioration of this portion can be suppressed, and thereby a battery with higher safety can be provided. In one example embodiment of the present invention, the PET separator, particularly the PET separator used as the intermediate layer separator is larger than the positive electrode that is in contact with the PET separator, and the difference in length between them is preferably 1 mm or more, more preferably 2 mm or more, further preferably 3 mm or more. The upper limit of the difference in length is not particularly limited, but in the case of a stacked type battery, if the separator is excessively large, the volume of the battery becomes large and the energy density decrease. Therefore, the difference in length between the separator and the electrode is usually 10 mm or less. In the case of a wound type battery, the same lower limit as described above is also preferable, but the upper limit is not particularly limited because it has little influence on the energy density. Regarding the length, when the member is circular, the diameter length is used; and when the member is square, the long side length is used. In one example embodiment of the present invention, the ratio of the area of the portion that is not in contact with the positive electrode in the area of the PET separator, particularly the PET separator used as the intermediate layer separator, is preferably 3% or more, more preferably 5% or more and further preferably 10% or more. The upper limit of the ratio is not particularly limited, but is, for example, 20% or less. When the battery comprises a plurality of PET separators, such PET separator(s) having portion(s) that is(are) not in contact with the positive electrode(s) may be all PET separators or a part of PET separators.

In one example embodiment, it is particularly preferable that the PET separator has a portion that is in contact with the negative electrode on one surface and is not in contact with the negative electrode nor the positive electrode on the other surface (hereinafter, also referred to as a portion in contact with only the negative electrode). For example, the outermost layer separator laminated on the negative electrode is in contact with the negative electrode on one surface and is not in contact with the negative electrode nor the positive electrode on the other surface. Therefore, the outermost layer separator laminated on the negative electrode has a portion in contact with only the negative electrode. Further, even the intermediate layer separator may have a portion in contact with only the negative electrode in some cases. The negative electrode may be designed larger than the positive electrode for the purpose of suppressing the generation of dendrites and the like. As described above, the separator is usually designed to be larger than the negative electrode in order to enhance the safety against the displacement of the electrode laminate. In this case, the intermediate layer separator has a portion in contact with only the negative electrode. Even in a wound type battery, since the negative electrode is usually larger than the positive electrode for the purpose of suppressing the generation of dendrites, the separator has a portion in contact with only the negative electrode. Further, for the purpose of preventing the active material from falling off and of facilitating the assembly, the outermost part is often made to be an uncoated current collector part as an electrode terminal portion or a separator. When the negative electrode is arranged outside the positive electrode and wound, the separator at the outermost part is in contact with only the negative electrode. The PET separator is particularly easily deteriorated in such a portion in contact with only the negative electrode. However, according to the present invention, deterioration of this portion can be suppressed, and various types of lithium ion secondary batteries can be provided.

In one example embodiment of the present invention, the ratio of the total area of the portion in contact with only the negative electrode to the total area of the PET separator is preferably 1% or more, more preferably 4% or more, further preferably 7% or more, and particularly preferably 10% or more. The upper limit of the ratio is not particularly limited, but, for example, it is 70% or less. Here, the total area of the separator is the total value of the areas of all the separators included in the battery, and the total area of the portion in contact with only the negative electrode is the total value of the areas of the portions in contact with only the negative electrodes that exist in all the separators included in the battery. Usually, the area of the portion in contact with only the negative electrode in the intermediate layer separator is equal to the difference between the area of the negative electrode and the area of the positive electrode. Usually, the area of the portion of the outermost layer separator in contact with only the negative electrode is equal to the area of the negative electrode.

[Negative Electrode]

The negative electrode comprises a negative electrode current collector and a negative electrode mixture layer comprising a negative electrode active material and a negative electrode binder.

In the present example embodiment, a solution type binder is used as the negative electrode binder. Binders used for electrodes of lithium ion secondary batteries are generally mixed with an active material and a solvent in the process of manufacturing the electrodes, and these are classified into dispersion type binders and solution type binders. For example, the dispersion type binder is used as an emulsion by dispersing binder particles in a solvent. The dispersed binder particles bind the active material particles through the steps of applying them to the current collector and drying the solvent. The solution type binder is used by being dissolved in a solvent. When the solution type binder is dissolved, a coating film of the binder is formed on the surface of the active material particles, and the coating film binds the active material particles through the same steps of applying them to the current collector and drying the solvent. By coating the negative electrode active material particles with the solution type binder, a side reaction between the negative electrode active material and the electrolyte solution can be suppressed. As a result, the generation of a substance that decomposes PET is suppressed, and thereby deterioration of the PET separator can be suppressed.

Examples of the solution type binder that may be used include polyvinylidene fluoride (PVdF), vinylidene fluoride-hexafluoropropylene copolymer, vinylidene fluoride-tetrafluoroethylene copolymer, polytetrafluoroethylene, polypropylene, polyethylene, polybutadiene, polyacrylic acid, polyacrylic acid ester, polystyrene, polyacrylonitrile, polyimide, polyamideimide, polyamide or the like. The solution type binder may be used alone or in combination of two or more kinds. The solvent that dissolves the solution type binder is not particularly limited and may be appropriately determined depending on the binder. Examples of the solvent include water and organic solvents such as N-methylpyrrolidone.

From the viewpoint of “sufficient binding force” and “high energy density” that are in a trade-off relation with each other, the amount of the solvent type binder for use in the negative electrode is preferably 0.1 to 30 parts by mass, and more preferably 0.5 to 20 parts by mass based on 100 parts by mass of the negative electrode active material.

The negative electrode active material is not particularly limited as long as it is a material capable of reversibly absorbing and desorbing lithium ions with charge and discharge. Specific examples include metals, metal oxides, carbon materials and the like.

Examples of the metal include Li, Al, Si, Pb, Sn, In, Bi, Ag, Ba, Ca, Hg, Pd, Pt, Te, Zn, La, and alloys of two or more of these. Two or more kinds of these metals or alloys may be mixed and used. These metals or alloys may contain one or more non-metallic elements.

Examples of the metal oxide include silicon oxide, aluminum oxide, tin oxide, indium oxide, zinc oxide, lithium oxide, and a composite of these. In the present example embodiment, the negative electrode active material of the metal oxide comprises preferably tin oxide or silicon oxide, and more preferably silicon oxide. This is because silicon oxide is relatively stable and less likely to cause a reaction with other compounds. As silicon oxide, those represented by the composition formula: SiOₓ (where 0<x≤2) are preferable. One or or two or more element(s) selected from nitrogen, boron and sulfur may be added to the metal oxide, for example, in an amount of 0.1 to 5 mass %. This may improve the electrical conductivity of the metal oxide.

The surface of the metal or the metal oxide may be coated with carbon. In some cases, carbon coating can improve cycle characteristics. The carbon coating can be formed by, for example, a sputtering method or a vapor deposition method using a carbon source.

Example of the carbon material include graphite, amorphous carbon, graphene, diamond-like carbon, a carbon nanotube, or composite thereof. Highly crystalline graphite has high electrical conductivity and is excellent in adhesion to a negative electrode current collector made of a metal such as copper and in voltage flatness. On the other hand, amorphous carbons having a low crystallinity exhibit relatively small volume expansion, and therefore have effect of highly relaxing the volume expansion of the whole negative electrode, and hardly undergo the degradation due to nonuniformity such as crystal grain boundaries and defects.

The negative electrode may comprise an electrically conductive assistant agent including carbonaceous fine particles such as graphite, carbon black, and acetylene black from the viewpoint of improving electrical conductivity.

As the negative electrode current collector, aluminum, nickel, stainless steel, chromium, copper, silver and alloys thereof may be used from the viewpoint of electrochemical stability. Examples of its shape include foil, a flat plate shape, and a mesh shape.

The negative electrode according to the present example embodiment may be produced, for example, by preparing a negative electrode slurry containing a negative electrode active material, a negative electrode binder, and a solvent, and applying this slurry to a negative electrode current collector to form a negative electrode mixture layer. Examples of the method for forming the negative electrode mixture layer include a doctor blade method, a die coater method, a CVD method, and a sputtering method. After forming the negative electrode mixture layer in advance, a thin film of aluminum, nickel, or an alloy thereof as a negative electrode current collector may be formed thereon by a method such as vapor deposition, sputtering, or the like to produce the negative electrode.

[Positive Electrode]

The positive electrode comprises a positive electrode current collector and a positive electrode mixture layer comprising a positive electrode active material and a positive electrode binder.

The positive electrode active material may be selected from several viewpoints. From the viewpoint of increasing energy density, it preferably comprises a compound with high capacity. Examples of the high capacity compound include lithium nickelate (LiNiO₂) and lithium nickel composite oxides in which a part of Ni of lithium nickelate is replaced by another metal element, and layered lithium nickel composite oxides represented by the following formula (1) are preferred.

Li_{y}Ni₍₁₋ₓ₎MₓO₂ (1)

wherein 0≤x<1, 0<y≤1.2, and M is at least one element selected from the group consisting of Co, Al, Mn, Fe, Ti, and B.

From the viewpoint of high capacity, it is preferred that the content of Ni is high, that is, x is less than 0.5, further preferably 0.4 or less in the formula (1). Examples of such compounds include Li_{α}Ni_{β}Co_{γ}Mn_{δ}O₂ (0<α≤1.2, preferably 1≤α≤1.2, ρ+γ+δ=1, β≥0.7, and γ≤0.2) and Li_{α}Ni_{β}Co_{γ}Al_{δ}O₂ (0<α≤1.2, preferably 1≤α≤1.2, β+γ+8=1, β≥0.6, preferably β≥0.7, and γ≤0.2) and particularly include LiNi_{β}Co_{γ}Mn_{δ}O₂ (0.75≤β≤0.85, 0.05≤γ≤0.15, and 0.10≤δ≤0.20). More specifically, for example, LiNi_{0.8}Co_{0.05}Mn_{0.15}O₂, LiNi_{0.8}Co_{0.1}Mn_{0.1}O₂, LiNi_{0.8}Co_{0.15}Al_{0.05}O₂, and LiNi_{0.8}Co_{0.1}Al_{0.1}O₂ may be preferably used.

From the viewpoint of thermal stability, it is also preferred that the content of Ni does not exceed 0.5, that is, x is 0.5 or more in the formula (1). In addition, it is also preferred that particular transition metals do not exceed half. Examples of such compounds include Li_{α}Ni_{β}Co_{y}Mn_{δ}O₂ (0<α≤1.2, preferably 1≤α≤1.2, β+γ+δ=1, 0.2≤β≤0.5, 0.1≤γ≤0.4, and 0.1≤δ≤0.4). More specific examples may include LiNi_{0.4}Co_{0.3}Mn_{0.3}O₂ (abbreviated as NCM433), LiNi_{1/3}Co_{1/3}Mn_{1/3}O₂, LiNi_{0.5}Co_{0.2}Mn_{0.3}O₂ (abbreviated as NCM523), and LiNi_{0.5}Co_{0.3}Mn_{0.2}O₂ (abbreviated as NCM532) (also including those in which the content of each transition metal fluctuates by about 10% in these compounds).

In addition, two or more compounds represented by the formula (1) may be mixed and used, and, for example, it is also preferred that NCM532 or NCM523 and NCM433 are mixed in the range of 9:1 to 1:9 (as a typical example, 2:1) and used. Further, by mixing a material in which the content of Ni is high (x is 0.4 or less in the formula (1)) and a material in which the content of Ni does not exceed 0.5 (x is 0.5 or more, for example, NCM433), a battery having high capacity and high thermal stability can also be formed.

The layered lithium nickel composite oxide may be further substituted by other metal element(s). For example, the layered lithium nickel composite oxide represented by the following formula (2) may also be preferably used.

LiₐNi_{b}Co_{c}M1_{d}M2ₑO_{f} (2)

(0.8≤a≤1.2, 0.5≤b<1.0, 0.005≤c≤0.4, 0.005≤d≤0.4, 0≥e<0.1, 1.8≤f≤2.3, b+c+d+e=1, M1 is Mn or Al, M2 is one or more metals selected from the group consisting of B, Na, Mg, Al, S, K, Ca, Ti, V, Cr, Fe, Cu, Zn, Zr, Nb, Mo, Sn, Pb and W.)

Examples of the positive electrode active materials other than the above include lithium manganate having a layered structure or a spinel structure such as LiMnO₂, LiₓMn₂O₄ (0<x<2), Li₂MnO₃, xLi₂MnO₃-(1-x)LiMO₂ (x satisfies 0.1<x<0.8, M is one or more elements selected from the group consisting of Mn, Fe, Co, Ni, Ti, Al and Mg.) and LiₓMn_{1.5}Ni_{0.5}O₄ (0<x<2); LiCoO₂ or materials in which a part of the transition metal in this material is replaced by other metal(s); materials in which Li is excessive as compared with the stoichiometric composition in these lithium transition metal oxides; materials having olivine structure such as LiFePO4, and the like. In addition, materials in which a part of elements in these metal oxides is substituted by Al, Fe, P, Ti, Si, Pb, Sn, In, Bi, Ag, Ba, Ca, Hg, Pd, Pt, Te, Zn, La and the like may also be used. The positive electrode active materials described above may be used alone or in combination of two or more.

Examples of the positive electrode binder include, but are not particularly limited to, polyvinylidene fluoride, vinylidene fluoride-hexafluoropropylene copolymer, vinylidene fluoride-tetrafluoroethylene copolymer, polytetrafluoroethylene, polypropylene, polyethylene, polybutadiene, polyacrylic acid, polyacrylic acid ester, polystyrene, polyacrylonitrile, polyimide, polyamideimide and the like may be used. The positive electrode binder may be a mixture of the above-mentioned plurality of resins, a copolymer and a cross-linked product thereof, such as styrene-butadiene rubber (SBR). When an aqueous binder such as an SBR-based emulsion is used, a thickener such as carboxymethyl cellulose (CMC) may be used. The amount of the positive electrode binder is, as a lower limit, preferably 1 part by mass or more, and more preferably 2 parts by mass or more and, as an upper limit, preferably 30 parts by mass or less, and more preferably 25 parts by mass or less, based on 100 parts by mass of the positive electrode active material.

For the purpose of reducing the impedance, the positive electrode mixture layer may additionally comprise an electrically conductive assistant agent. Examples of the electrically conductive assistant agent include flake-like, soot-like or fibrous carbonaceous fine particles, and examples thereof include graphite, carbon black, acetylene black, vapor grown carbon fiber and the like.

As the positive electrode current collector, from the viewpoint of electrochemical stability, aluminum, nickel, copper, silver, and alloys thereof are preferable. Examples of its shape include foil, a flat-plate shape, and a mesh shape. In particular, a current collector using aluminum, an aluminum alloy, or iron-nickel-chromium-molybdenum-based stainless steel is preferable.

The positive electrode according to the present example embodiment may be produced, for example, by preparing a positive electrode slurry containing a positive electrode active material, a positive electrode binder and a solvent, applying it to a positive electrode current collector, to form a positive electrode mixture layer. Examples of a method of forming the positive electrode mixture layer include a doctor blade method, a die coater method, a CVD method, a sputtering method, and the like. After forming the positive electrode mixture layer in advance, a thin film of aluminum, nickel or an alloy thereof as a positive electrode current collector may be formed thereon by a method such as vapor deposition or sputtering to produce a positive electrode.

### [Electrolyte Solution]

The electrolyte solution comprises a solvent and a supporting salt. In the present example embodiment, the solvent comprises a carbonate-based solvent, that is, a compound having a carbonate group (—OC(═O)O—). In the present example embodiment, the compound having a carbonate group is not particularly limited, and may be a cyclic carbonate or an open-chain carbonate.

The cyclic carbonate is not particularly limited, but examples thereof include ethylene carbonate (EC), propylene carbonate (PC), and butylene carbonate (BC). A fluorinated cyclic carbonate may be used. Examples of the fluorinated cyclic carbonate include compounds in which a part or all of hydrogen atoms of ethylene carbonate (EC), propylene carbonate (PC), butylene carbonate (BC) and the like are substituted by fluorine atom(s). More specifically, for example, 4-fluoro-1,3-dioxolan-2-one (monofluoroethylene carbonate), (cis or trans)4,5-difluoro-1,3-dioxolan-2-one, 4,4-difluoro-1,3-dioxolan-2-one, 4-fluoro-5-methyl-1,3-dioxolan-2-one and the like may be used. The cyclic carbonates may be used alone or in combination of two or more.

The open-chain carbonate is not particularly limited, but examples thereof include dimethyl carbonate (DMC), ethylmethyl carbonate (EMC), diethyl carbonate (DEC), dipropyl carbonate (DPC) and the like. The open-chain carbonate also includes a fluorinated open-chain carbonate. Examples of the fluorinated chain carbonate may include compounds in which a part or all of hydrogen atoms of ethyl methyl carbonate (EMC), dimethyl carbonate (DMC), diethyl carbonate (DEC), dipropyl carbonate (DPC) and the like are substituted by fluorine atom(s). Specific examples of the fluorinated opne-chain carbonate include bis(fluoroethyl)carbonate, 3-fluoropropyl methyl carbonate, and 3,3,3-trifluoropropyl methyl carbonate. The open-chain carbonate may be used alone or in combination of two or more.

Since the compound having a carbonate group has a high dielectric constant, the electrolyte solution containing the compound having a carbonate group can improve ionic dissociation and reduce viscosity. In addition to the film-forming effect, the ion mobility can be improved. Therefore, the volume ratio of the compound having a carbonate group in the solvent is preferably 10% by volume or more, more preferably 50% by volume or more, and may be 100% by volume.

The compound having a carbonate group may be used in combination with other solvent(s). Examples of other solvents include a sulfone compound, a carboxylic acid ester, an ether, and a phosphoric acid ester.

The sulfone compound may be an open-chain or cyclic sulfone. Examples of the open-chain sulfone compound include dimethyl sulfone, ethyl methyl sulfone, diethyl sulfone, butyl methyl sulfone, dibutyl sulfone, methyl isopropyl sulfone, diisopropyl sulfone, methyl tert-butyl sulfone, butyl ethyl sulfone, butyl propyl sulfone, butyl isopropyl sulfone, di-tert-butyl sulfone, diisobutyl sulfone, ethyl isopropyl sulfone, ethyl isobutyl sulfone, tert-butyl ethyl sulfone, propyl ethyl sulfone, isobutyl isopropyl sulfone, butyl isobutyl sulfone and isopropyl (1-methyl-propyl) sulfone. Examples of the cyclic sulfone compound include sulfolane (i.e. tetramethylene sulfone), methylsulfolanes such as 3-methylsulfolane, 3,4-dimethylsulfolane, 2,4-dimethylsulfolane, trimethylene sulfone (thietane 1,1-dioxide), 1-methyl trimethylene sulfone, pentamethylene sulfone, hexamethylene sulfone and ethylene sulfone.

The carboxylic acid ester is not particularly limited, but examples thereof include an open-chain carboxylic acid ester such as ethyl acetate, methyl propionate, ethyl formate, ethyl propionate, methyl butyrate, ethyl butyrate, methyl acetate, methyl formate and the like; and a cyclic carboxylic acid ester including γ-lactones such as γ-butyrolactone, α-methyl-γ-butyrolactone and 3-methyl-γ-butyrolactone, ß-propiolactone, δ-valerolactone, and the like. The fluorinated compounds of these carboxylic acid esters may be used.

Examples of the ether include dimethyl ether, diethyl ether, ethyl methyl ether, dimethoxyethane and the like.

A fluorine-containing ether may be used. Examples of the fluorine-containing ether include 2,2,3,3,3-pentafluoropropyl 1,1,2,2-tetrafluoroethyl ether, 1,1,2,2-tetrafluoroethyl 2,2,2-trifluoroethyl ether, 1H,1H,2′H,3H-decafluorodipropyl ether, 1,1,2,3,3,3-hexafluoropropyl 2,2-difluoroethyl ether, isopropyl 1,1,2,2-tetrafluoroethyl ether, propyl 1,1,2,2-tetrafluoroethyl ether, 1,1,2,2-tetrafluoroethyl 2,2,3,3-tetrafluoropropyl ether, 1H,1H,5H-perfluoropentyl 1,1,2,2-tetrafluoroethyl ether, 1H-perfluorobutyl 1H-perfluoroethyl ether, methyl perfluoropentyl ether, methyl perfluorohexyl ether, methyl 1,1,3,3,3-pentafluoro-2-(trifluoromethyl)propyl ether, 1,1,2,3,3,3-hexafluoropropyl 2,2,2-trifluoroethyl ether, ethyl nonafluorobutyl ether, ethyl 1,1,2,3,3,3-hexafluoropropyl ether, 1H,1H,5H-octafluoropentyl 1,1,2,2-tetrafluoroethyl ether, 1H,1H,2′H-perfluorodipropyl ether, heptafluoropropyl 1,2,2,2-tetrafluoroethyl ether, methyl nonafluorobutyl ether, 1,1-difluoroethyl 2,2,3,3-tetrafluoropropyl ether, bis(2,2,3,3-tetrafluoropropyl)ether, 1,1-difluoroethyl-2,2,3,3,3-pentafluoropropyl ether, 1,1-difluoroethyl 1H, 1H-heptafluorobutyl ether, 2,2,3,4,4,4-hexafluorobutyl difluoromethyl ether, bis(2,2,3,3,3-pentafluoropropyl)ether, nonafluorobutyl methyl ether, bis(1H,1H-heptafluorobutyl)ether, 1,1,2,3,3,3-hexafluoropropyl 1H,1H-heptafluorobutyl ether, 1H, 1H-heptafluorobutyl trifluoromethyl ether, 2,2-difluoroethyl 1,1,2,2-tetrafluoroethyl ether, bis(trifluoroethyl) ether, bis(2,2-difluoroethyl) ether, bis(1,1,2-trifluoroethyl) ether, 1,1,2-trifluoroethyl 2,2,2-trifluoroethyl ether and the like.

Examples of the phosphoric acid ester include trimethyl phosphate, triethyl phosphate, tributyl phosphate and the like.

A fluorine-containing phosphoric acid ester may be used. Examples of the fluorine-containing phosphoric acid ester include 2,2,2-trifluoroethyl dimethyl phosphate, bis(trifluoroethyl) methyl phosphate, bistrifluoroethyl ethyl phosphate, tris(trifluoromethyl) phosphate, pentafluoropropyl dimethyl phosphate, heptafluorobutyl dimethyl phosphate, trifluoroethyl methyl ethyl phosphate, pentafluoropropyl methyl ethyl phosphate, heptafluorobutyl methyl ethyl phosphate, trifluoroethyl methyl propyl phosphate, pentafluoropropyl methyl propyl phosphate, heptafluorobutyl methyl propyl phosphate, trifluoroethyl methyl butyl phosphate, pentafluoropropyl methyl butyl phosphate, heptafluorobutyl methyl butyl phosphate, trifluoroethyl diethyl phosphate, pentafluoropropyl diethyl phosphate, heptafluorobutyl diethyl phosphate, trifluoroethyl ethyl propyl phosphate, pentafluoropropyl ethyl propyl phosphate, heptafluorobutyl ethyl propyl phosphate, trifluoroethyl ethyl butyl phosphate, pentafluoropropyl ethyl butyl phosphate, heptafluorobutyl ethyl butyl phosphate, trifluoroethyl dipropyl phosphate, pentafluoropropyl dipropyl phosphate, heptafluorobutyl dipropyl phosphate, trifluoroethyl propyl butyl phosphate, pentafluoropropyl propyl butyl phosphate, heptafluorobutyl propyl butyl phosphate, trifluoroethyl dibutyl phosphate, pentafluoropropyl dibutyl phosphate, heptafluorobutyl dibutyl phosphate, tris(2,2,3,3-tetrafluoropropyl) phosphate, tris(2,2,3,3,3-pentafluoropropyl) phosphate, tris(2,2,2-trifluoroethyl) phosphate, tris(1H,1H-heptafluorobutyl) phosphate, tris(1H,1H,5H-octafluoropentyl) phosphate and the like.

In the present example embodiment, the electrolyte solution preferably further comprises an additive. The additive forms a film on the negative electrode during charge and discharge, and can suppress decomposition of a solvent such as a compound having a carbonate group. Thus, the additive can further suppress the deterioration of the PET separator. Examples of the additive include fluoroethylene carbonate, vinylene carbonate, a cyclic disulfonic acid ester, propane sultone, and an unsaturated acid anhydride.

A fluoroethylene carbonate is obtained by replacing at least a part of hydrogens of ethylene carbonate with fluorine. The substitution ratio of fluorine and the substitution position of fluorine are not particularly limited, but 4-fluoro-1,3-dioxolan-2-one is particularly preferable. The fluoroethylene carbonate may also be used as a solvent. When fluoroethylene carbonate is used as the solvent, the additive may not be used, or other compounds may be used as the additive. In one example embodiment, fluoroethylene carbonate is preferably used as an additive rather than as a solvent.

The cyclic disulfonic acid ester is represented by, for example, the following formula (3).

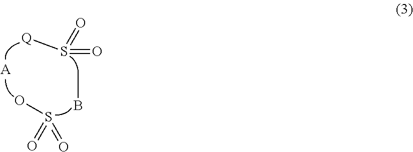

wherein

Q represents an oxygen atom, methylene group, or a single bond;

A represents a substituted or unsubstituted alkylene group having 1 to 6 carbon atoms, carbonyl group, sulfinyl group, a substituted or unsubstituted fluoroalkylene group having 1 to 6 carbon atoms, or a group having 2 to 6 carbon atoms in which alkylene units or fluoroalkylene units are bonded through an ether bond; and

B represents a substituted or unsubstituted alkylene group having 1 to 6 carbon atoms, a substituted or unsubstituted fluoroalkylene group having 1 to 6 carbon atoms, or an oxygen atom.)

In the formula (3), Q represents an oxygen atom, methylene group, or a single bond, and an oxygen atom (—O—) is preferred.

In the formula (3), A represents a substituted or unsubstituted alkylene group having 1 to 6 carbon atoms; carbonyl group; sulfinyl group; a substituted or unsubstituted fluoroalkylene group having 1 to 6 carbon atoms; or a group having 2 to 6 carbon atoms in which alkylene units or fluoroalkylene units are bonded through an ether bond. In the formula (3), when A represents an alkylene group, it may be either straight or branched, and is preferably straight. In the case of a straight alkylene group, the alkylene group is represented by —(CH₂)ₙ— (n is an integer of 1 to 6), is more preferably a methylene group or an ethylene group represented by —(CH₂)ₙ— (n is 1 or 2), and is furthermore preferably a methylene group. In the branched alkylene group, at least one hydrogen atom of the alkylene group represented by —(CH₂)ₙ— (n is an integer of 1 to 5) is substituted by an alkyl group; examples of the branched alkylene group include —C(CH₃)₂—, —C(CH₃)(CH₂CH₃)—, —C(CH₂CH₃)₂—, —CH(CₘH₂ₘ₊₁)— (m is an integer of 1 to 4), —CH₂—C(CH₃)₂—, —CH₂—CH(CH₃)—, —CH(CH₃)—CH(CH₃)—, —CH(CH₃)CH₂CH₂— or —CH(CH₃)CH₂CH₂CH₂—. The fluoroalkylene group means a group in which at least one of the hydrogen atoms in each of the foregoing alkylene groups is substituted by fluorine atom. All the hydrogen atoms may be substituted by fluorine atoms. The position and the number of the fluorine substitution are arbitrary. The fluoroalkylene group may either be straight or branched, and is preferably straight. When all the hydrogen atoms are substituted by fluorine atoms in the straight fluoroalkylene group, A is represented by —(CF₂)ₙ— (n is an integer of 1 to 6). Specifically, examples of the fluoroalkylene group include monofluoromethylene group, difluoromethylene group, monofluoroethylene group, difluoroethylene group, trifluoroethylene group and tetrafluoroethylene group.

Examples of “a divalent group having 2 to 6 carbon atoms in which alkylene units or fluoroalkylene units are bonded through an ether bond” in A include —R⁴—O—R⁵— (R⁴ and R⁵ each independently represent an alkylene group or a fluoroalkylene group, and the total number of carbon atoms of R⁴ and R⁵ is 2 to 6), and —R⁶—O—R⁷—O—R⁸— (R⁶, R⁷ and R⁸ each independently represent an alkylene group or a fluoroalkylene group, and the total number of carbon atoms of R⁶, R⁷ and R⁸ is 3 to 6). R⁴ and R⁵ may both be alkylene groups or fluoroalkylene groups, or one of R⁴ and R⁵ may be an alkylene group and the other may be a fluoroalkylene group. R⁶, R⁷ and R⁸ may each independently be an alkylene group or a fluoroalkylene group. Examples thereof include —CH₂—O—CH₂—, —CH₂—O—C₂H₄—, —C₂H₄—O—C₂H₄—, —CH₂—O—CH₂—O—CH₂—, —CH₂—O—CHF—, —CH₂—O—CF₂—, —CF₂—O—CF₂—, —C₂F₄—O—C₂F₄—, —CF₂—O—CF₂—O—CF₂—, —CH₂—O—CF₂—O—CH₂—.

In the formula (3), B represents a substituted or unsubstituted alkylene group having 1 to 6 carbon atoms; a substituted or unsubstituted fluoroalkylene group having 1 to 6 carbon atoms; or an oxygen atom. B may be either straight or branched. As the alkylene group and the fluoroalkylene group, the groups described as the above A may be exemplified. Among those, B is preferably a methylene group (—CH₂—) or —CH(CₘH₂ₘ₊₁)— (m is an integer of 1 to 4), more preferably a methylene group, ethylidene group [—CH(CH₃)—] or —CH(C₂H₅)—, further preferably —CH(CH₃)— or a methylene group.

The cyclic disulfonic acid ester is preferably a six-membered ring or a seven-membered ring, and examples thereof include methylene methanedisulfonic acid ester (MMDS) in which, A and B are each methylene group, and Q is an oxygen atom in the formula (3); ethylene methanedisulfonic acid ester (EMDS) in which A is ethylene group, B is methylene group, and Q is an oxygen atom; and 3-methyl-1,5,2,4-dioxadithiane-2,2,4,4,-tetraoxide (3MDT) in which A is methylene group, B is ethylidene group [—CH(CH₃)—], and Q is an oxygen atom.

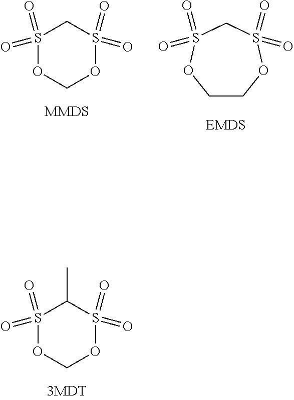

The cyclic disulfonic acid ester may be used alone or in combination of two or more thereof.

Examples of the unsaturated acid anhydride include carboxylic acid anhydrides, sulfonic acid anhydrides, and anhydrides of a carboxylic acid and a sulfonic acid. Among them, the unsaturated acid anhydride is preferably a carboxylic acid anhydride having a structure represented by [—(C═O)—O—(C═O)—] in the molecule. Preferred examples of the unsaturated acid anhydride include maleic anhydride, 2,3-dimethylmaleic anhydride, itaconic anhydride, citraconic anhydride and the like. You may use fluorinated compounds of these.

From the viewpoint of forming a film that suppresses the decomposition of the PET separator, the content of the additive in the electrolyte solution is preferably 0.05% by mass or more, more preferably 0.1% by mass or more, and further preferably 0.4% by mass or more. The content of the additive in the electrolyte solution is preferably 3% by mass or less, more preferably 2% by mass or less, and further preferably 1.5% by mass or less. When the amount of the additive is large, the film becomes thick and thereby the capacity may deteriorate. Thus, the amount of the additive is preferably small. In the present example embodiment, since the solution type binder that coats the active material is used, a sufficient film-forming effect can be obtained even if the amount of the additive is small.

The supporting salt is not particularly limited as long as it contains Li. Examples of the supporting salt include LiPF₆, LiAsF₆, LiAlCl₄, LiClO₄, LiBF₄, LiSbF₆, LiCF₃SO₃, LiC₄F₉SO₃, LiC(CF₃SO₂)₃, LiN(FSO₂)₂, LiN(CF₃SO₂)₂, LiN(C₂F₅SO₂)₂, and LiB₁₀Cl₁₀. In addition, examples of other supporting salts include lithium lower aliphatic carboxylates, chloroborane lithium, lithium tetraphenylborate, LiBr, LiI, LiSCN, and LiCl. One supporting salt may be used alone, or two or more supporting salts may be used in combination.

The concentration of the supporting salt in the electrolyte solution is preferably 0.5 to 1.5 mol/L. When the concentration of the supporting salt is within this range, the density, viscosity, electric conductivity and the like can be easily adjusted within an appropriate range.

### [Insulation Layer]

An insulation layer may be formed on at least one surface of the positive electrode, the negative electrode and the separator. Examples of a method for forming the insulation layer include a doctor blade method, a die coater method, a CVD method, a sputtering method and the like. The insulation layer may be formed at the same time as forming the positive electrode mixture layer, the negative electrode mixture layer, or the separator. Examples of materials constituting the insulation layer include a mixture of an insulating filler such as aluminum oxide, barium titanate or the like and the binder such as styrene butadiene rubber or polyvinylidene fluoride.

### [Structure of Lithium Ion Secondary Battery]

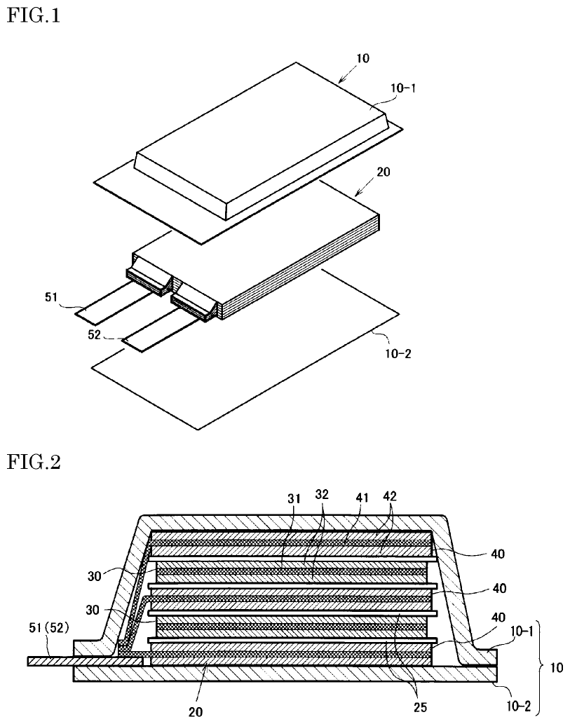

A secondary battery according to the present example embodiment has, for example, a structure as shown in FIG. 1 and FIG. 2. This secondary battery comprises a battery element 20, a film package 10 housing the battery element 20 together with an electrolyte, and a positive electrode tab 51 and a negative electrode tab 52 (hereinafter these are also simply referred to as “electrode tabs”).

In the battery element 20, a plurality of positive electrodes 30 and a plurality of negative electrodes 40 are alternately stacked with separators 25 sandwiched therebetween as shown in FIG. 2. In the positive electrode 30, an electrode material 32 is applied to both surfaces of a metal foil 31, and also in the negative electrode 40, an electrode material 42 is applied to both surfaces of a metal foil 41 in the same manner. The present invention is not limited to the stacked type battery, but may be applied to a wound type battery or the like.

A secondary battery of the present example embodiment may have an arrangement in which the electrode tabs are drawn out on one side of the package as shown in FIG. 1 and FIG. 2, the electrode tabs may be drawn out on both sides of the outer package. Although detailed illustration is omitted, the metal foils of the positive electrodes and the negative electrodes each have an extended portion in part of the outer periphery. The extended portions of the negative electrode metal foils are brought together into one and connected to the negative electrode tab 52, and the extended portions of the positive electrode metal foils are brought together into one and connected to the positive electrode tab 51 (see FIG. 2). The portion in which the extended portions are brought together into one in the stacking direction in this manner is also referred to as a “current collecting portion” or the like.

The film package 10 is composed of two films 10-1 and 10-2 in this example. The films 10-1 and 10-2 are heat-sealed to each other in the peripheral portion of the battery element 20 and hermetically sealed. In FIG. 1, the positive electrode tab 51 and the negative electrode tab 52 are drawn out in the same direction from one short side of the film package 10 hermetically sealed in this manner.

Of course, the electrode tabs may be drawn out from different two sides respectively. In addition, regarding the arrangement of the films, in FIG. 1 and FIG. 2, an example in which a cup portion is formed in one film 10-1 and a cup portion is not formed in the other film 10-2 is shown, but other than this, an arrangement in which cup portions are formed in both films (not illustrated), an arrangement in which a cup portion is not formed in either film (not illustrated), and the like may also be adopted.

### [Method for Manufacturing Lithium Ion Secondary Battery]

The lithium ion secondary battery according to the present example embodiment can be manufactured according to a usual method. An example of a method for manufacturing a lithium ion secondary battery will be described taking a stacked laminate type lithium ion secondary battery as an example. First, in the dry air or an inert atmosphere, the positive electrode and the negative electrode are placed to oppose to each other via a separator to form the electrode laminate. Next, this electrode laminate is accommodated in an outer package (container), an electrolyte solution is injected, and the electrode is impregnated with the electrolyte solution. Thereafter, the opening of the outer package is sealed to complete the lithium ion secondary battery.

### [Assembled Battery]

A plurality of lithium ion secondary batteries according to the present example embodiment may be combined to form an assembled battery. The assembled battery may be configured by connecting two or more lithium ion secondary batteries according to the present example embodiment in series or in parallel or in combination of both. The connection in series and/or parallel makes it possible to adjust the capacitance and voltage freely. The number of lithium ion secondary batteries included in the assembled battery can be set appropriately according to the battery capacity and output.

### [Vehicle]

The lithium ion secondary battery or the assembled battery according to the present example embodiment can be used in vehicles. Examples of the vehicle according to the present example embodiment include hybrid vehicles, fuel cell vehicles, electric vehicles (besides four-wheel vehicles (cars, trucks, commercial vehicles such as buses, light automobiles, etc.), two-wheeled vehicle (bike) and tricycle), and the like. The vehicles according to the present example embodiment are not limited to automobiles, and the batteries may be used in a variety of power sources of other vehicles, such as a moving body like a train, a ship, a submarine and a satellite.

### [Power Storage Device]

The lithium ion secondary battery or the assembled battery according to the present embodiment can be used in a power storage device. The power storage devices according to the present example embodiment include, for example, those which is connected between the commercial power supply and loads of household appliances and used as a backup power source or an auxiliary power in the event of power outage or the like, or those used as a large scale power storage that stabilize power output with large time variation supplied by renewable energy, for example, solar power generation.

### EXAMPLE

Specific examples according to the present invention will be described below, but the present invention is not limited to these examples

### Example 1

### (Preparation of Positive Electrode)

A positive electrode active material (layered lithium nickel composite oxide: LiNi_{0.80}Co_{0.15}Al_{0.05}O₂), carbon black (trade name: “#3030B”, manufactured by Mitsubishi Chemical Corporation), and polyvinylidene fluoride (trade name: “W #7200”, manufactured by Kureha Co., Ltd.) were weighed respectively so that the mass ratio thereof was 93:2:5. These were mixed with N-methylpyrrolidone (NMP) to obtain a positive electrode slurry. The mass ratio of NMP and the solid components was 50:50. This positive electrode slurry was applied to an aluminum foil having a thickness of 15 μm using a doctor blade. The aluminum foil coated with the positive electrode slurry was heated at 120° C. for 5 minutes to dry the NMP and to prepare a positive electrode.

### (Preparation of Negative Electrode)

A composite in which the surface of SiOₓ having an average particle diameter D50% of 8 μm was coated with carbon (the amount of carbon in the composite is 7% by mass) and the polyamic acid solution (trade name: “U-varnish A”, manufactured by Ube Industries Ltd., polyamic acid content is 20% by mass) were respectively weighed so that the mass ratio thereof was 50:50. These were kneaded with NMP to obtain a negative electrode slurry. The negative electrode slurry was applied to a copper foil having a thickness of 10 μm using a doctor blade. Then, it was heated at 300° C. for 5 minutes, and NMP was dried. Subsequently, it was heated in air at 150° C. under normal pressure for 1 hour to prepare a negative electrode.

### (Separator)

A PET non-woven fabric (thickness: 15 μm, porosity: 56%, Gurley value: 0.2 sec/100 cc) was used.

### (Assembly of Secondary Battery)

An aluminum terminal and a nickel terminal were respectively welded to the prepared positive electrode and the prepared negative electrode. These were stacked via a separator to prepare an electrode laminate. The separator sandwiched between the electrodes is referred to as “an intermediate layer separator”. Separately from this, separators were further placed on the top and the bottom sides of the obtained electrode laminate to provide a separator that was in contact with only the negative electrode. These are referred to as “the outermost layer separator”. The negative electrode was larger than the positive electrode (by 2 mm on each side), and the separator was larger than the negative electrode (by 2 mm on each side). As a result, there was a portion having a width of 4 mm in the peripheral portion of the intermediate layer separator that did not face the positive electrode. This portion was 3.5% to the area of the separator. The total area of the portion in contact with only the negative electrode to the total area of the separators was 7.0%.

The electrode laminate on which the outermost layer separator was placed was housed in a laminate film, and the electrolyte solution was injected into the laminate film. Then, the laminated film was thermally fusion-bonded and sealed while the inside of the laminate film was being depressurized. In this manner, a plurality of flat type secondary batteries before initial charging were prepared. A polypropylene film on which aluminum was vapor-deposited was used as the laminate film. As the electrolyte solution, a solution containing 1.0 mol/1 of LiPF₆ as a supporting salt and a mixed solvent of ethylene carbonate and diethyl carbonate (7:3 (volume ratio)) as a solvent was used.

### (Storage Test of Secondary Battery)

The prepared secondary battery was charged to 4.2 V and left for 20 days in a thermostatic bath kept at 45° C. to perform a storage test. Charge was performed by the CCCV method, and after reaching 4.2V, the voltage was kept constant for 1 hour. The molecular weight of the separator which was taken out from the battery disassembled after discharging was measured, and it was used as an indicator of the deterioration of the separator. The molecular weights of the peripheral portion of the intermediate layer separator that did not face the positive electrode and of the central portion of the outermost layer separator were measured. When the weight average molecular weight of the separator was lowered by 10% or more as compared with that of the unused one, it was evaluated as x; when the lowering of the weight average molecular weight was less than 10%, it was evaluated as ∘; and when no change was observed, it was evaluated as ∘∘. The results are shown in Table 1.

### (Molecular Weight Measurement)

The molecular weight of PET was measured by GPC as follows. The sample was dissolved in 1,1,1,3,3,3-hexafluoro-2-propanol (HFIP) and then filtered through a membrane filter to obtain a measurement solution. DMF (10 mM, LiBr) was used as an eluent, and the RI detector was used for measurement. The molecular weight of PET before use was Mn=21,000.

### (Safety Test)

A high temperature storage test was conducted as a safety test. The prepared secondary battery was charged to 4.2 V and then left in a thermostatic bath at 160° C. for 30 minutes to evaluate the state of the battery. When the battery did not explode nor ignite, it was evaluated as ∘; and when it ignited, it was evaluated as x. The results are shown in Table 1.

### Example 2

A battery was prepared and evaluated in the same manner as in Example 1 except that the negative electrode was changed. The negative electrode was prepared as follows. Copolymerized polyacrylic acid comprising monomer units derived from sodium acrylate was used as the negative electrode binder. A composite in which the surface of SiOₓ having an average particle diameter D50% of 8 μm was coated with carbon (the amount of carbon in the composite was 7% by mass) and polyacrylic acid were weighed so that the mass ratio thereof was 90:10. These were mixed with pure water to prepare a negative electrode slurry. This was applied to both sides of a copper foil having a thickness of 10 μm as a current collector, dried at 80° C. for 5 minutes, and subjected to a pressing step to prepare a negative electrode.

### Example 3

A battery was prepared and evaluated in the same manner as in Example 2 except that fluoroethylene carbonate (FEC) (1.5% by mass) as an additive was added to the electrolyte solution.

### Example 4

A battery was prepared and evaluated in the same manner as in Example 2 except that vinylene carbonate (VC) (1.5% by mass) as an additive was added to the electrolyte solution.

### Example 51

A battery was prepared and evaluated in the same manner as in Example 2 except that methylene methane disulfonic acid ester (MMDS) (1.5% by mass) as an additive was added to the electrolyte solution.

### Example 61

A battery was prepared and evaluated in the same manner as in Example 1 except that fluoroethylene carbonate (FEC) (1.5% by mass) as an additive was added to the electrolyte solution.

### Example 71

A battery was prepared and evaluated in the same manner as in Example 1 except that vinylene carbonate (VC) (1.5 mass %) as an additive was added to the electrolyte solution.

### Example 81

A battery was prepared and evaluated in the same manner as in Example 1 except that methylene methane disulfonic acid ester (MMDS) (1.5% by mass) as an additive was added to the electrolyte solution.

### Example 91

A battery was prepared and evaluated in the same manner as in Example 2 except that the negative electrode was changed. The negative electrode was prepared as follows. Natural graphite was used as the negative electrode active material. Natural graphite as a negative electrode active material, acetylene black as an electrically conductive assistant agent, and copolymerized polyacrylic acid comprising monomer units derived from sodium acrylate as a negative electrode binder were weighed so that the mass ratio thereof is 90:1:10. These were mixed with pure water to prepare a negative electrode slurry. This was applied to both sides of a copper foil having a thickness of 10 μm as a current collector, dried at 80° C. for 5 minutes, and subjected to a pressing step to produce a negative electrode.

### Example 101

A battery was prepared and evaluated in the same manner as in Example 9 except that fluoroethylene carbonate (FEC) (1.5% by mass) as an additive was added to the electrolyte solution.

### Example 11

A battery was prepared and evaluated in the same manner as in Example 9 except that vinylene carbonate (VC) (1.5 mass %) as an additive was added to the electrolyte solution.

### Example 12

A battery was prepared and evaluated in the same manner as in Example 9 except that methylene methane disulfonic acid ester (MMDS) (1.5% by mass) as an additive was added to the electrolyte solution.

### Example 13

A battery was prepared and evaluated in the same manner as in Example 2 except that the positive electrode active material was the layered lithium nickel composite oxide (LiNi_{0.80}Mn_{0.15}Co_{0.05}O₂).

### Example 14

A battery was prepared and evaluated in the same manner as in Example 3 except that the positive electrode active material was the layered lithium nickel composite oxide (LiNi_{0.80}Mn_{0.15}Co_{0.05}O₂).

### Example 15

A battery was prepared and evaluated in the same manner as in Example 4 except that the positive electrode active material was the layered lithium nickel composite oxide (LiNi_{0.80}Mn_{0.15}Co_{0.05}O₂).

### Example 16

A battery was prepared and evaluated in the same manner as in Example 5 except that the positive electrode active material was the layered lithium nickel composite oxide (LiNi_{0.80}Mn_{0.15}Co_{0.05}O₂).

### Example 17

A battery was prepared and evaluated in the same manner as in Example 14 except that fluoroethylene carbonate (FEC) (0.5% by mass) as an additive was added to the electrolyte solution.

### Example 18

A battery was prepared and evaluated in the same manner as in Example 15 except that vinylene carbonate (VC) (0.5% by mass) as an additive was added to the electrolyte solution.

### Example 19

A battery was prepared and evaluated in the same manner as in Example 16 except that methylene methane disulfonic acid ester (MMDS) (0.5% by mass) as an additive was added to the electrolyte solution.

### Example 20

A battery was prepared and evaluated in the same manner as in Example 14 except that fluoroethylene carbonate (FEC) (0.3% by mass) as an additive was added to the electrolyte solution.

### Example 21

A battery was prepared and evaluated in the same manner as in Example 15, except that vinylene carbonate (VC) (0.3% by mass) as an additive was added to the electrolyte solution.

### Example 22

A battery was prepared and evaluated in the same manner as in Example 16 except that methylene methane disulfonic acid ester (MMDS) (0.3% by mass) as an additive was added to the electrolyte solution.

### Comparative Example 1

A battery was prepared and evaluated in the same manner as in Example 1 except that the negative electrode was changed. The negative electrode was prepared as follows. Artificial graphite and an aqueous solution comprising 1% by mass of carboxymethyl cellulose (CMC) were kneaded using a rotation/revolution mixer (Awatori Rentaro ARE-500 manufactured by Thinky Corporation), and then styrene butadiene rubber (SBR) was added to prepare a negative electrode slurry. The mass ratio of artificial graphite, CMC and SBR was 97:1:2. This was applied to both sides of a copper foil having a thickness of 10 μm as a current collector, dried at 80° C. for 5 minutes, and subjected to a pressing step to produce a negative electrode.

### Comparative Example 2

A battery was prepared and evaluated in the same manner as in Comparative Example 1 except that fluoroethylene carbonate (FEC) (1.5% by mass) as an additive was added to the electrolyte solution.

### Comparative Example 3

A battery was prepared and evaluated in the same manner as in Comparative Example 1 except that vinylene carbonate (VC) (1.5 mass %) as an additive was added to the electrolyte solution.

### Comparative Example 4

A battery was prepared and evaluated in the same manner as in Comparative Example 1 except that methylene methane disulfonic acid ester (MMDS) (1.5% by mass) as an additive was added to the electrolyte solution.

### Comparative Example 5

A battery was prepared and evaluated in the same manner as Comparative Example 1 except that the separator was changed to polypropylene (PP). The molecular weight of polypropylene was measured by GPC as follows. The sample was dissolved in o-dichlorobenzene and then filtered through a membrane filter to obtain a measurement solution. o-dichlorobenzene was used as an eluent and measurement was performed with an RI detector. The molecular weight of polypropylene before use was Mw=600,000.

### Comparative Example 6

A battery was prepared and evaluated in the same manner as in Example 1 except that the separator was changed to polypropylene.

### Comparative Example 7

A battery was prepared and evaluated in the same manner as in Example 2 except that the separator was changed to polypropylene.

### Comparative Example 8

A battery was prepared and evaluated in the same manner as in Example 9 except that the separator was changed to polypropylene.

TABLE 1

| | | | | | | | | | | Molecular weight | |
|---|---|---|---|---|---|---|---|---|---|---|---|
| | | | | | | | | | | peripheral | Central |
| | Positive | | | Negative | | | | | | portion of | portion of |
| | electrode | Positive | | electrode | Negative | Additive in electrolyte | | | | intermediate | outermost |
| | active | electrode | | active | electrode | solution(wt %) | | | | layer | layer |
| | material | binder | Separator | material | binder | FEC | VC | MMDS | safety | separator | separator |
| Ex. 1 | NCA | PVdF | PET | SiO | PI | — | — | — | ∘ | ∘∘ | ∘ |
| Ex. 2 | NCA | PVdF | PET | SiO | PAA | — | — | — | ∘ | ∘∘ | ∘ |
| Ex. 3 | NCA | PVdF | PET | SiO | PAA | 1.5 | — | — | ∘ | ∘∘ | ∘∘ |
| Ex. 4 | NCA | PVdF | PET | SiO | PAA | — | 1.5 | — | ∘ | ∘∘ | ∘∘ |
| Ex. 5 | NCA | PVdF | PET | SiO | PAA | — | — | 1.5 | ∘ | ∘∘ | ∘∘ |
| Ex. 6 | NCA | PVdF | PET | SiO | PI | 1.5 | — | — | ∘ | ∘∘ | ∘∘ |
| Ex. 7 | NCA | PVdF | PET | SiO | PI | — | 1.5 | — | ∘ | ∘∘ | ∘∘ |
| Ex. 8 | NCA | PVdF | PET | SiO | PI | — | — | 1.5 | ∘ | ∘∘ | ∘∘ |
| Ex. 9 | NCA | PVdF | PET | C | PAA | — | — | — | ∘ | ∘∘ | ∘ |
| Ex. 10 | NCA | PVdF | PET | C | PAA | 1.5 | — | — | ∘ | ∘∘ | ∘∘ |
| Ex. 11 | NCA | PVdF | PET | C | PAA | — | 1.5 | — | ∘ | ∘∘ | ∘∘ |
| Ex. 12 | NCA | PVdF | PET | C | PAA | — | — | 1.5 | ∘ | ∘∘ | ∘∘ |
| Ex. 13 | NMC | PVdF | PET | SiO | PAA | — | — | — | ∘ | ∘∘ | ∘ |
| Ex. 14 | NMC | PVdF | PET | SiO | PAA | 1.5 | — | — | ∘ | ∘∘ | ∘∘ |
| Ex. 15 | NMC | PVdF | PET | SiO | PAA | — | 1.5 | — | ∘ | ∘∘ | ∘∘ |
| Ex. 16 | NMC | PVdF | PET | SiO | PAA | — | — | 1.5 | ∘ | ∘∘ | ∘∘ |
| Ex. 17 | NMC | PVdF | PET | SiO | PAA | 0.5 | — | — | ∘ | ∘∘ | ∘∘ |
| Ex. 18 | NMC | PVdF | PET | SiO | PAA | — | 0.5 | — | ∘ | ∘∘ | ∘∘ |
| Ex. 19 | NMC | PVdF | PET | SiO | PAA | — | — | 0.5 | ∘ | ∘∘ | ∘∘ |
| Ex. 20 | NMC | PVdF | PET | SiO | PAA | 0.3 | — | — | ∘ | ∘∘ | ∘ |
| Ex. 21 | NMC | PVdF | PET | SiO | PAA | — | 0.3 | — | ∘ | ∘∘ | ∘ |
| Ex. 22 | NMC | PVdF | PET | SiO | PAA | — | — | 0.3 | ∘ | ∘∘ | ∘ |
| Com. Ex. 1 | NCA | PVdF | PET | C | SBR | — | — | — | ∘ | x | x |
| Com. Ex. 2 | NCA | PVdF | PET | C | SBR | 1.5 | — | — | ∘ | ∘ | x |
| Com. Ex. 3 | NCA | PVdF | PET | C | SBR | — | 1.5 | — | ∘ | ∘ | x |
| Com. Ex. 4 | NCA | PVdF | PET | C | SBR | — | — | 1.5 | ∘ | ∘ | x |
| Com. Ex. 5 | NCA | PVdF | PP | C | SBR | — | — | — | x | ∘∘ | ∘∘ |
| Com. Ex. 6 | NCA | PVdF | PP | SiO | PI | — | — | — | x | ∘∘ | ∘∘ |
| Com. Ex. 7 | NCA | PVdF | PP | SiO | PAA | — | — | — | x | ∘∘ | ∘∘ |
| Com. Ex. 8 | NCA | PVdF | PP | C | PAA | — | — | — | x | ∘∘ | ∘∘ |

Ex. = Example,
Com. Ex. = Comparative Example

The meanings of the abbreviations in Table 1 are as follows.

NCA: LiNi_{0.80}Co_{0.15}Al_{0.05}O₂
NMC: LiNi_{0.80}Mn_{0.15}Co_{0.05}O₂
PET: polyethylene terephthalate
PP: polypropylene
PVdF: polyvinylidene fluoride
C: graphite (natural graphite or artificial graphite)
PI: polyimide
PAA: polyacrylic acid
SBR: styrene butadiene rubber
FEC: fluoroethylene carbonate
VC: vinylene carbonate
MMDS: methylene methane disulfonic acid ester

In Comparative Examples 5 to 8 in which polypropylene having a melting point lower than that of PET was used for the separator, the safety thereof was inferior in the high temperature storage test. It is presumed that the separator shrank, and thereby short circuit and ignition were caused.

In Comparative Examples 1 to 4 using SBR, which is a dispersion type binder as the negative electrode binder, a decrease in the molecular weight of PET was observed in the peripheral portion of the intermediate layer separator and in the central portion of the outermost layer separator, and particularly in the outermost layer separator, a significant decrease in molecular weight occurred. It is inferred that in those portions that are placed at a distance from the positive electrode, the alkoxy ions, which are the causative substances of deterioration, are hard to oxidize, and thus the decomposition reaction of PET occurs violently. Further, such result was particularly conspicuous in Comparative Example 1 in which no additive was used in the electrolyte solution. This indicates that the surface of the negative electrode active material is covered with the coating film generated by the additive, and thereby the alkoxy ions, which are the causative substances of the deterioration, is hardly generated.

Example 9 uses polyacrylic acid, which is a solution type binder, as the negative electrode binder. On the other hand, Comparative Example 1 uses SBR, which is a dispersion type binder, as the negative electrode binder. It is indicated that in Example 9, the decrease in the molecular weight of the PET separator is suppressed as compared with Comparative Example 1. It is inferred that the solution type binder covered the surface of the negative electrode active material, and thereby the alkoxy ions, which are the causative substances of deterioration, is hardly generated. Further, it was demonstrated that in Examples 10 to 12 in which the additive was added to the electrolyte solution, the decrease in the molecular weight of the separator was further suppressed.

In Examples 13 to 22, the amount of additive was changed. Even in Example 13 in which the additive was not used, the deterioration of the intermediate layer separator could be suppressed. However, as shown in Examples 14 to 22, by adding the additive in an amount of 0.5% by mass or more, deterioration of both of the intermediate layer separator and the outermost layer separator could be suppressed.

The whole or part of the example embodiments disclosed above can be described as, but not limited to, the following supplementary notes.

### (Supplementary Note 1)

A lithium ion secondary battery comprising:

an electrode laminate comprising a positive electrode, a negative electrode and a separator, and

an electrolyte solution, wherein

the negative electrode comprises a solution type binder,

the separator comprises polyethylene terephthalate, and

the electrolyte solution comprises a solvent comprising a compound having a carbonate group.

### (Supplementary Note 2)

The lithium ion secondary battery according to the supplementary note 1, wherein the solution type binder is selected from the group consisting of polyacrylic acid, polyimide, and polyamide.

### (Supplementary Note 3)

The lithium ion secondary according to the supplementary note 1 or 2, wherein the electrolyte solution comprises an additive selected from the group consisting of fluoroethylene carbonate, vinylene carbonate, a cyclic disulfonic acid ester, propane sultone, and an unsaturated acid anhydride.

### (Supplementary Note 4)

The lithium ion secondary battery according to the supplementary note 3, wherein the content of the additive in the electrolyte solution is 0.05% by mass or more and 3% by mass or less.

### (Supplementary Note 5)

The lithium ion secondary battery according to any one of the supplementary notes 1 to 4, wherein the separator has a portion that is in contact with the negative electrode on one surface and is not in contact with the positive electrode nor the negative electrode on the other surface.

### (Supplementary Note 6)

The lithium ion secondary battery according to the supplementary note 5, wherein the ratio of the total area of the portion to the total area of the separator is 1% or more.

### (Supplementary Note 7)

The lithium ion secondary battery according to any one of supplementary notes 1 to 6, comprising a plurality of the separators, wherein a part of the separators is in contact with the negative electrode on one surface and is not in contact with the positive electrode nor the negative electrode on the other surface.

### (Supplementary Note 8)

The lithium ion secondary battery according to any one of the supplementary notes 1 to 6, wherein at least one outermost layer of the electrode laminate is the separator stacked on the negative electrode.

### (Supplementary Note 9)

The lithium ion secondary battery according to any one of the supplementary notes 1 to 8, which is a stacked type.

### (Supplementary Note 10)

A vehicle equipped with the lithium ion secondary battery according to any one of the supplementary notes 1 to 9.

### (Supplementary Note 11)

A method for manufacturing a lithium ion secondary battery,

stacking a positive electrode and a negative electrode via a separator to prepare an electrode laminate,

enclosing the electrode laminate and the electrolyte solution in an outer package, wherein

the negative electrode comprises a solution type binder,

the separator comprises polyethylene terephthalate, and

the electrolyte solution comprises a solvent comprising a compound having a carbonate group.

This application is based upon and claims the benefit of priority from Japanese patent application No. 2018-054602, filed on Mar. 22, 2018, the disclosure of which is incorporated herein in its entirety by reference.

While the invention has been particularly shown and described with reference to example embodiments and examples thereof, the invention is not limited to these embodiments and examples. It will be understood by those of ordinary skill in the art that various changes in form and details may be made therein without departing from the spirit and scope of the present invention as defined by the claims.

### INDUSTRIAL APPLICABILITY

The lithium ion secondary battery according to the present example embodiment can be utilized, for example, in various industrial fields that require for an electric power source and in an industrial field concerning transportation, storage and supply of electric energy. Specifically, it can be utilized for, for example, an electric power source of a mobile device such as a mobile phone and a notebook computer; an electric power source of a moving or transport medium including an electric vehicle such as an electric car, a hybrid car, an electric motorcycle and an electric power-assisted bicycle, a train, a satellite and a submarine; a back-up electric power source such as UPS; and an electric power storage device for storing an electric power generated by solar power generation, wind power generation; and the like.

### EXPLANATION OF REFERENCE

10 film outer package
20 battery element
25 separator
30 positive electrode
40 negative electrode
a negative electrode
b separator
b-1 separator
b-2 separator
c positive electrode
d negative electrode current collector
e positive electrode current collector
f positive electrode terminal
g negative electrode terminal

1. A lithium ion secondary battery comprising:
an electrode laminate comprising a positive electrode, a negative electrode and a separator, and
an electrolyte solution, wherein
the negative electrode comprises a solution type binder,
the separator comprises polyethylene terephthalate, and
the electrolyte solution comprises a solvent comprising a compound having a carbonate group.

2. The lithium ion secondary battery according to claim 1, wherein the solution type binder is selected from the group consisting of polyacrylic acid, polyimide, and polyamide.

3. The lithium ion secondary according to claim 1, wherein the electrolyte solution comprises an additive selected from the group consisting of fluoroethylene carbonate, vinylene carbonate, a cyclic disulfonic acid ester, propane sultone, and an unsaturated acid anhydride.

4. The lithium ion secondary battery according to claim 3, wherein the content of the additive in the electrolyte solution is 0.05% by mass or more and 3% by mass or less.

5. The lithium ion secondary battery according to claim 1, wherein the separator has a portion that is in contact with the negative electrode on one surface and is not in contact with the positive electrode nor the negative electrode on the other surface.

6. The lithium ion secondary battery according to claim 5, wherein the ratio of the total area of the portion to the total area of the separator is 1% or more.

7. The lithium ion secondary battery according to claim 1, wherein at least one outermost layer of the electrode laminate is the separator stacked on the negative electrode.

8. The lithium ion secondary battery according to claim 1, which is a stacked type.

9. A vehicle equipped with the lithium ion secondary battery according to claim 1.

10. A method for manufacturing a lithium ion secondary battery,
stacking a positive electrode and a negative electrode via a separator to prepare an electrode laminate,
enclosing the electrode laminate and the electrolyte solution in an outer package, wherein
the negative electrode comprises a solution type binder,
the separator comprises polyethylene terephthalate, and
the electrolyte solution comprises a solvent comprising a compound having a carbonate group.
